(19) United States
(12) Patent Application Publication
(10) Pub. No.: US 2015/0302096 A1
(43) Pub. Date: Oct. 22, 2015

(54) INFORMATION PROCESSING SYSTEM, INFORMATION PROCESSING APPARATUS, AND PROGRAM

(71) Applicant: Ayumi IWASAKI, Tokyo (JP)

(72) Inventor: Ayumi IWASAKI, Tokyo (JP)

(73) Assignee: RICOH COMPANY, LTD., Tokyo (JP)

(21) Appl. No.: 14/681,315

(22) Filed: Apr. 8, 2015

(30) Foreign Application Priority Data
Apr. 18, 2014 (JP) 2014-086283

(51) Int. Cl. G06F 17/30; H04L 29/08

(52) U.S. Cl. CPC G06F 17/30867; H04L 67/32

(57) ABSTRACT

An information processing system including a plurality of terminal devices and at least one information processing apparatus, wherein each of the at least one information processing apparatus includes an administrating unit that administrates information related to sharing information shared between the plurality of terminal devices, a search performing unit that searches the information related to the sharing information to find the information related to the sharing information as a search target based on a search request in which search information is designated, a search result sending unit that sends a search result to the plurality of terminal devices, wherein each of the plurality of terminal devices includes a search result receiving unit that receives the search result, and a display unit that displays information exchanged between the plurality of terminal devices and the received search result.

### BACKGROUND OF THE INVENTION

1. Field of the Invention

The present invention relates to an information processing system, an information processing apparatus, and a program.

2. Description of the Related Art

There is a dialogue processing apparatus which provides related information more suitable for the content of a current dialogue without causing a speaker to be conscious of the related information. The dialogue processing apparatus extracts a keyword from dialogue information spoken by the dialogist, and a related information acquiring unit acquires related information related to the dialogue from a related information database and provides the dialogist with the related information.

Patent Document 1: Japanese Laid-Open Patent Publication No. 2003-186896

### SUMMARY OF THE INVENTION

It is an object of at least one embodiment of the present invention to provide an information processing system, an information processing apparatus, and a program that substantially obviates one or more problems caused by the limitations and disadvantages of the related art.

One aspect of the embodiments of the present invention may be to provide an information processing system including a plurality of terminal devices and at least one information processing apparatus, wherein each of the at least one information processing apparatus includes an administrating unit that administrates information related to sharing information shared between the plurality of terminal devices, a search performing unit that searches the information related to the sharing information to find the information related to the sharing information as a search target based on a search request in which search information is designated, a search result sending unit that sends a search result to the plurality of terminal devices, wherein each of the plurality of terminal devices includes a search result receiving unit that receives the search result, and a display unit that displays information exchanged between the plurality of terminal devices and the received search result.

Additional objects and advantages of the embodiments will be set forth in part in the description which follows, and in part will be clear from the description, or may be learned by practice of the invention. Objects and advantages of the invention will be realized and attained by means of the elements and combinations particularly pointed out in the appended claims.

It is to be understood that both the foregoing general description and the following detailed description are exemplary and explanatory only and are not restrictive of the invention as claimed.

### BRIEF DESCRIPTION OF THE DRAWINGS

FIG. 1 illustrates an exemplary structure of an information processing system of an embodiment.

FIG. 2 illustrates an exemplary hardware structure of a computer of the embodiment.

FIG. 3 illustrates an exemplary hardware structure of a smart device of the embodiment.

FIG. 4 is an exemplary processing block chart of a smart device of the embodiment.

FIG. 5 is an exemplary processing block chart of a chat server of the embodiment.

FIG. 6 is an exemplary processing block chart of a relay server of the embodiment.

FIG. 7 is an exemplary processing block chart of a file server of the embodiment.

FIG. 8 schematically illustrates a file search of the embodiment.

FIG. 9 illustrates a file search process of the embodiment.

FIG. 10 is an exemplary sequence chart of the file search process of the embodiment.

FIG. 11 illustrates an exemplary process of determining a search key from a chat log.

FIG. 12 illustrates an exemplary image of a chat screen on which a keyword is designated for a search command.

FIG. 13 is an exemplary sequence chart of a file search process using a search key designated for a search command.

FIG. 14 is an exemplary image chart of a chat screen on which a message is selected as a search key by a user.

FIG. 15 is an exemplary sequence chart of a file search process using a message selected by a user as a search key.

FIG. 16 illustrates an exemplary use of a search result.

### DETAILED DESCRIPTION OF THE PREFERRED EMBODIMENTS

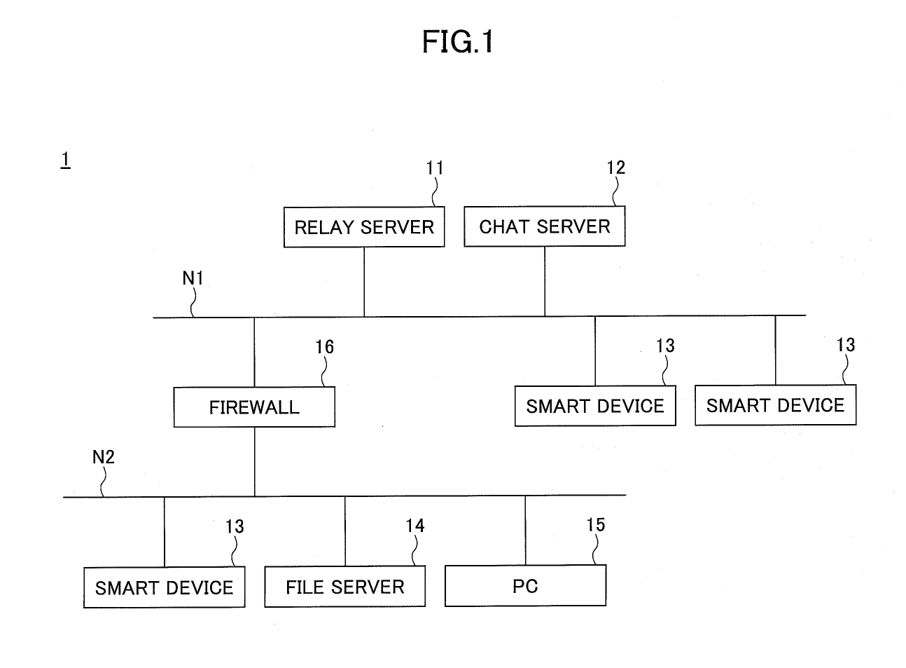

A description is given below, with reference to the FIG. 1 through FIG. 16 of embodiments of the present invention. Where the same reference symbols are attached to the same parts, repeated description of the parts is omitted.

Reference symbols typically designate as follows:
1: information processing system;
11: relay server;
12: chat server;
13: smart device;
14: file server;
15: PC;
16: firewall (FW);
21: display unit;
22: operation receiving unit;
23: request sending unit;
24: setup memory unit;
25: data sending unit;
26: data receiving unit;
27: file administrating unit;
41: data receiving unit;
42: data sending unit;
43: request sending unit;
44: message analyzing unit;
45: user administrating unit;
51: data receiving unit;
52: data memory unit;
53: request receiving unit;
54: data determining unit;
55: data sending unit;
61: request inquiring unit;
62: request processing unit;
63: search performing unit;
64: WebAPI;
65: storage monitoring unit;
66: chat log analyzing unit;
67: SMB connecting unit;
68: file storage;
69: chat log storing unit;
70: file administrating unit;
71: database (DB);
500: computer;
501: input device;
502: display device;
503: external I/F;
503a: recording medium;
504: RAM;
505: ROM;
506: CPU;
507: communication I/F;
508: HDD;
601: CPU;
602: ROM;
603: RAM;
604: EEPROM;
605: CMOS sensor;
606: acceleration and direction sensor;
607: recording medium;
608: medium drive;
609: audio input unit;
610: audio output unit;
611: antenna;
612: communication unit;
613: wireless LAN communication unit;
614: short-range wireless communication antenna;
615: short-range wireless communication unit;
616: display;
617: touch panel;
618: battery;
1000, 1020, 1200, 1300, 1400, 1420: chat screen;
1010: file view;
1210: message input box;
1310: message;
1320: search button;
1401: menu for various operations;
1410: preview screen;
B: bus; and
N1, N2: network.

There is a case where information sharing is conducted between multiple users who use an information processing apparatus such as a file server enabling file sharing. Further, there is a case where an information exchange is conducted between multiple users who use an information processing apparatus such as a chat server.

However, there is no structure for causing a function of the information sharing in the information processing system for the information sharing of the files between the multiple users and a function of the information exchange in the information processing system for the information exchange of a comment or the like between the multiple users to collaborate. In an example of the information processing system, when an information exchange of the sharing information is conducted using a function of exchanging information such as a comment and sharing information such as a file is required to be browsed, a user is required to search the sharing information and access it by himself or herself.

Embodiments of the present invention are described in detail below.

### First Embodiment

### System Structure

FIG. 1 illustrates an exemplary structure of an information processing system of the first embodiment. Referring to FIG. 1, the information processing system 1 includes a relay server 11, a chat server 12, smart devices 13, a file server 14, a PC 15, and a firewall (FW) 16.

The relay server 11, a chat server 12, and at least a part of the smart devices 13 are connected to a global network N1 such as the Internet. At least a part of the smart devices 13, the file server 14 and the PC 15 are connected to a local network N2 such as a LAN. The network N1 and the network N2 are connected through the FW 16.

The relay server 11 temporarily receives a request for the file server 14 connected to the network N2 from the chat server 12 or the smart device 13, each of which is connected to the network N1, and delivers the request to the file server 14.

However, because the relay server 11 cannot directly access the file server 14, the relay server 11 delivers the request from the chat server 12 or the smart device 13 to the file server 14 in response to an inquiry from the request received from the file server 14.

The chat server receives a message such as a content of conversation from the smart device 13 and delivers the message to another smart device 13 in the same group so that the chat server 12 provides a chat function to enable a chat between the smart devices 13. The chat server 12 sends a message to the file server 14 and causes the message to be stored in the file server 14 as a chat log. Further, the chat server can analyzes the message from the smart device 13 and can send a request corresponding to an analysis result to the file server 14 through the relay server 11.

The smart device 13 and the PC 15 are examples of a terminal device used by the user. The smart device 13 and the PC 15 can send a request to the file server 14. For example, the smart device 13 and the PC 15 can perform a request to store, acquire, or browse to the file server 14. Further, the smart device 13 and the POC 15 can perform a chat with another smart device 13 and another PC 15 using the chat server 12. The smart device 13 may be a terminal device used by the user such as a smartphone, a tablet terminal, a portable phone, and a notebook personal computer (PC).

The file server 14 has a file server function. A file shared by users, a message log of a message exchanged through the chat server 12, and so on are stored in the file server 14. Further, the file server 14 has a search function of searching a stored file.

Because the file server 14 is connected to the network N2, the relay server 11, the chat server 12, and the smart device 13, which are connected to the network N1, cannot directly access the file server 14. The file server 14 can access the relay server 11, the chat server 12, and the smart device 13, which are connected to the network N1.

The file server 14 continuously inquires the relay server 11 of whether the request is received or not. If the relay server 11 receives the request, the request is acquired from the relay server 11 and processed. Further, the file server 14 sends a processing result of processing the request to the relay server 11. The smart device 13 sending the request can receive the processing result of processing the request from the relay server 11. As such, the request from the smart device 13 connected to the network N1 to the file server 14 connected to the network N2 can be indirectly sent through the relay server 11.

The relay server 11, the chat server 12, and the smart device 13, which are connected to the network N1, are mutually communicable. Further, the smart device 13, the file server 14, and the PC 14, which are connected to the network N2, are mutually communicable.

The information processing system 1 illustrated in FIG. 1 is an example. Various system structures can be exemplified depending on a use or a purpose. For example, the relay server 11, the chat server 12, and the file server 14 may be structured so that processes performed by the relay server 11, the chat server 12, and the file server 14 are distributed to multiple computers. Alternatively, the relay server 11 and the chat server 12 may be integrated into a single computer.

### <Hardware Structure>

### <<Computer>>

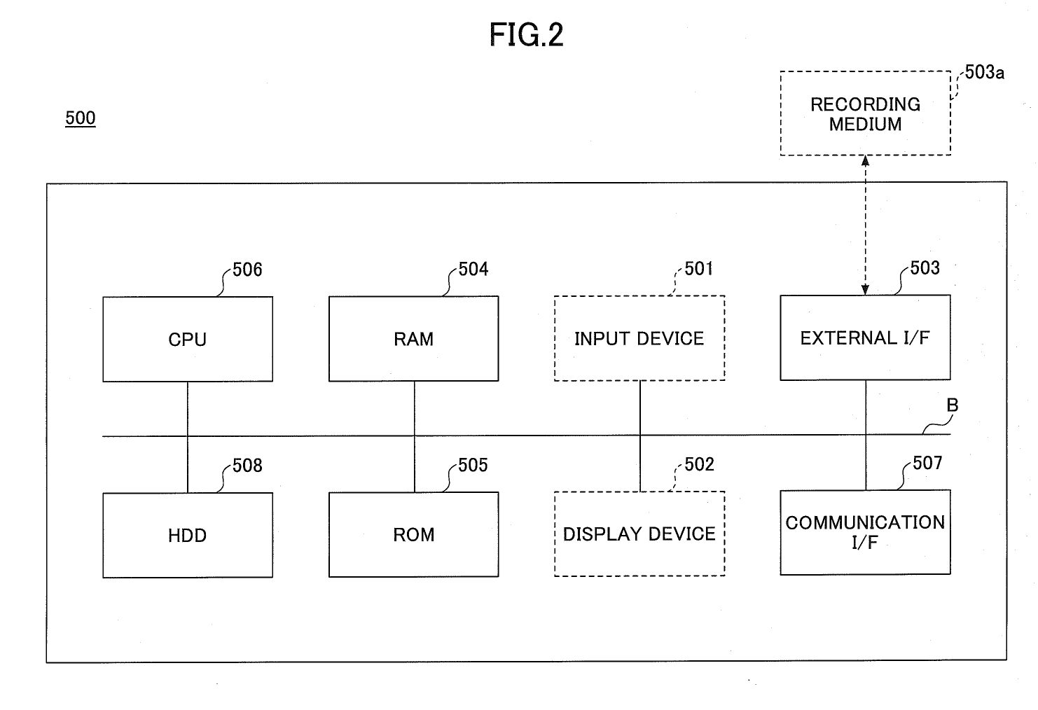

The relay server 11, the chat server 12, the file server 14, and the PC 15 are substantialized by a computer having a hardware structure illustrated in, for example, FIG. 2. FIG. 2 illustrates an exemplary hardware structure of the computer of the first embodiment.

Referring to FIG. 2, the computer 500 includes an input device 501, a display device 502, an external I/F 503, a RAM 504, a ROM 505, a CPU 506, a communication I/F 507, a HDD 508, and so on, mutually connected by a bus B. It is acceptable to structure such that the input device 501 and the display device 502 are connected when necessary.

The input device 501 includes a keyboard, a mouse, a touch panel, and so on, by which the user can input various operation signals. The display device 502 includes a display or the like, which displays a processing result obtained by the computer 500.

The communication I/F 507 is an interface provided to connect the computer 500 with the network N1 or N2. Thus, the computer 500 can perform data communications through the communication I/F 507.

The HDD 508 is a non-volatile memory device that stores programs and the data. The stored program and data are an operating system (OS), which is basic software controlling the entire computer 500, application software (hereinafter, simply referred to as an “application”) providing various functions in the OS, and so on. The computer 500 may use a drive device using a flash memory (e.g., a solid state drive (SSD)) as a memory medium in place of the HDD 508.

Further, the HDD 508 administrates the stored program and the stored data using a predetermined file system and/or a predetermined database (DB). The external I/F 503 is an interface with an external apparatus. The external apparatus includes a recording medium 503a or the like.

With this, the computer 500 can read information from the recording medium 503a and/or write information to the recording medium 503a through the external I/F 503. The recording medium 503a is a flexible disk, a CD, a DVD, an SD memory card, a USB memory, or the like.

The ROM 505 is a non-volatile semiconductor memory (a memory device), which can hold a program and/or data even when a power source is powered off. The ROM 505 stores programs and data such as a basic input/output system (BIOS), an OS setup, a network setup, or the like, which are executed at a time of booting up the computer 500. The RAM 504 is an example of a volatile semiconductor memory (a memory device) temporarily storing a program and/or data.

The CPU 506 reads the program and/or the data from the memory device such as the ROM 505, the HDD 508, or the like. The read program or the read data undergo a process to thereby substantialize a control or a function of the entire computer 500.

The relay server 11, the chat server 12, the file server 14, and the PC 15 are substantialized by the computer 500 having a hardware structure illustrated in, for example, FIG. 2.

### <Smart Device>

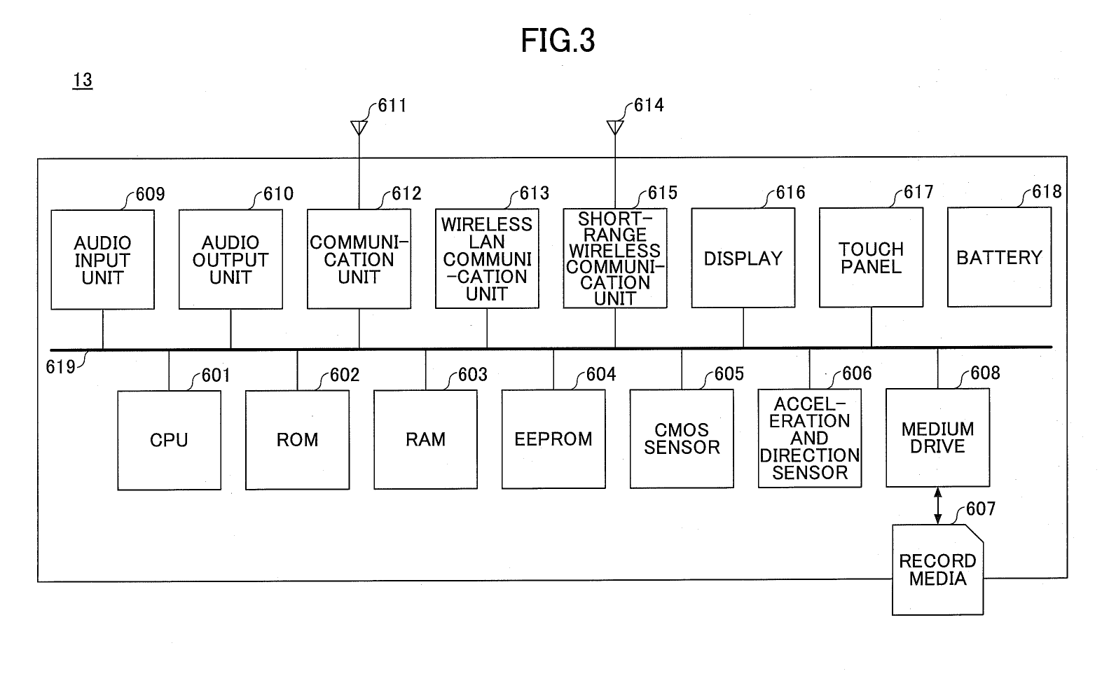

FIG. 3 illustrates an exemplary hardware structure of the smart device of the first embodiment. The smart device 13 illustrated in FIG. 3 includes a CPU 601, a ROM 602, a RAM 603, an EEPROM 604, a CMOS sensor 605, an acceleration and direction sensor 606, and a media drive 608.

The CPU 601 controls an operation of the entire smart device 13. The ROM 602 stores a basic input and output program. The RAM 603 is used as a work area of the CPU 601. The EEPROM 604 reads or writes data in conformity with a control of the CPU 601. The CMOS sensor 605 captures an object in conformity with a control of the CPU 601 to acquire image data. The acceleration and direction sensor 606 is an electromagnetic compass that detects earth magnetism, a gyrocompass, an acceleration sensor, or the like.

The media drive 608 controls read or write (store) of data from or to a record media 607 such as a flash memory. Data already recorded in the record media 607 are read out or new data are written in the record media 607. The record media 607 is freely attachable to or detachable from the media drive 608.

The EEPROM 604 stores an operating system (OS) executed by the CPU 601, association information necessary for a network setup, or the like. An application for performing various processes in the first embodiment is stored in the EEPROM 604, the record media 607, or the like.

The CMOS sensor 605 is a charge-coupled device that converts light to electric charges and digitizes an image of an object. The CMOS sensor 605 may be substituted by, for example, a charge coupled device (CCD) sensor as long as the image of the object can be captured.

Further, the smart device 13 includes an audio input unit 609, an audio output unit 610, an antenna 611, a communication unit 612, a wireless LAN communication unit 613, a short-range wireless communication antenna 614, a short-range wireless communication unit 615, a display 616, a touch panel 617, and a bus line 619.

The audio input unit 609 converts an audio to an audio signal. The audio output unit 610 converts the audio signal to the audio. The communication unit 612 uses the antenna 611 to communicate with the nearest base station apparatus by a wireless communication signal. The wireless LAN communication unit 613 performs a wireless LAN communication with an access point in conformity with the standard IEEE 80411. The short-range wireless communication unit 615 performs short-range wireless communication (Bluetooth, “Bluetooth” is a registered trademark) using the short-range wireless communication antenna 614.

The display 616 is provided to display an image of an object, various icons, or the like. The display 616 is made of a liquid crystal or an organic EL. The touch panel 617 is mounted on the display 616 and is formed of a panel of a pressure sensitive type or a static type. A touched position touched by a touch of a finger or a touch pen on the display 616 is detected. The bus line 619 is an address bus, a data bus, or the like for electrically connecting the above various portions.

The smart device 13 includes a battery 618 for a dedicated use. The smart device 13 is driven by the battery 618. The audio input unit 609 includes a microphone for inputting an audio. The audio output unit 610 includes a speaker for outputting the audio.

As described, the smart device 13 of the first embodiment can substantialize various processes described later with the above hardware structure.

### <Software Structure>

### <<Smart Device>>

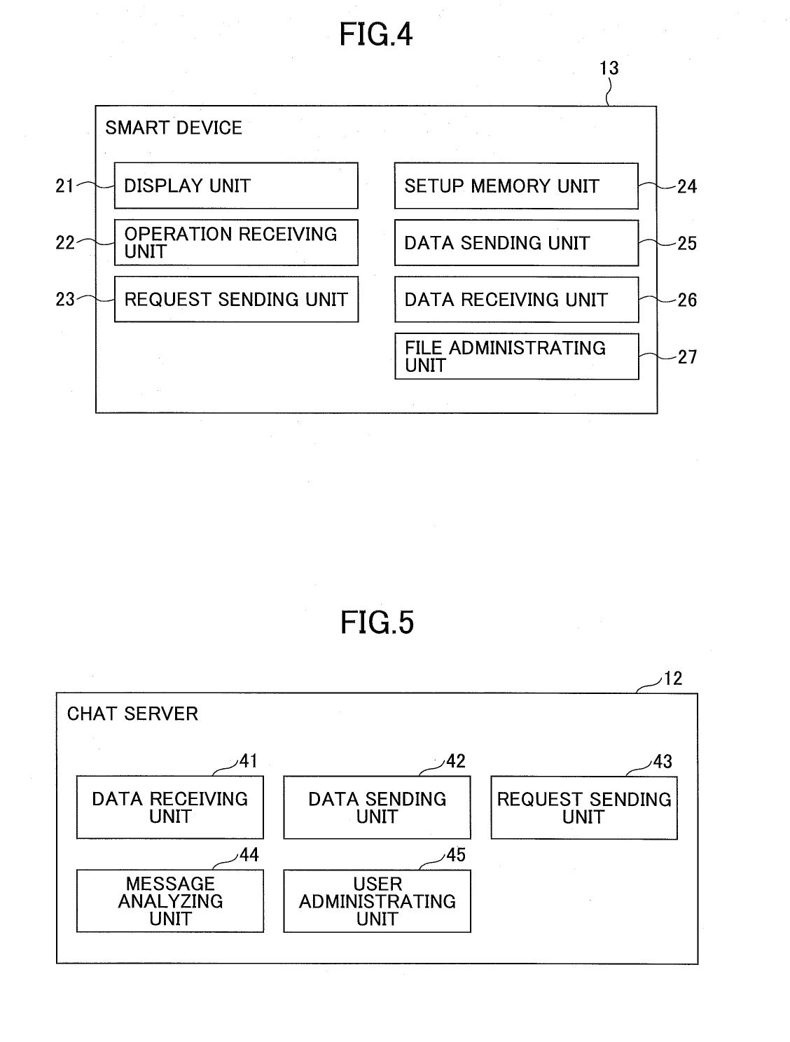

The smart device 13 of the first embodiment is substantialized by the processing block illustrated in, for example, FIG. 4. FIG. 4 is an exemplary processing block chart of the smart device of the first embodiment.

The smart device 13 substantializes a display unit 21, an operation receiving unit 22, a request sending unit 23, a setup memory unit 24, a data sending unit 25, a data receiving unit 26, and a file administrating unit 27 by running an application.

The display unit 21 displays a chat screen for displaying a message of a chat or the like, or a preview screen for displaying a file content or the like. The operations receiving unit 22 receives operations operated by the user. The request sending unit 23 sends various requests such as a search request to the file server 14. The setup memory unit 24 stores setups such as a user name, a password, a group, and so on.

Further, the data sending unit 25 sends the message of the chat or the like. The data receiving unit 26 receives the message of the chat, a search result, a file, and so on. The file administrating unit 27 stores or discards a cache of the received file.

### <<Chat Server>>

The chat server 12 of the first embodiment is substantialized by the processing block illustrated in, for example, FIG. 5. FIG. 5 is an exemplary processing block chart of the chat server of the first embodiment. For example, the chat server substantializes a data receiving unit 41, a data sending unit 42, a request sending unit 43, a message analyzing unit 44, and a user administrating unit 45 by running a program.

The data receiving unit 41 receives the message of the chat and so on. Further, the data sending unit 42 sends the message of the chat or the like. The data sending unit 42 uses the user administrating unit 45 to determine a group to which the message is sent.

The request sending unit 43 sends various requests such as a search request to the file server 14. The user administrating unit 45 administrates a user participating in the chat and a group to which a message of a conversation content of a chat is sent. The message analyzing unit 44 analyzes the message received by the data receiving unit 41. If the message analyzing unit 44 detects that the message includes a search command described below, the message analyzing unit 44 instructs the request sending unit 43 to send a search request.

### <<Relay Server>>

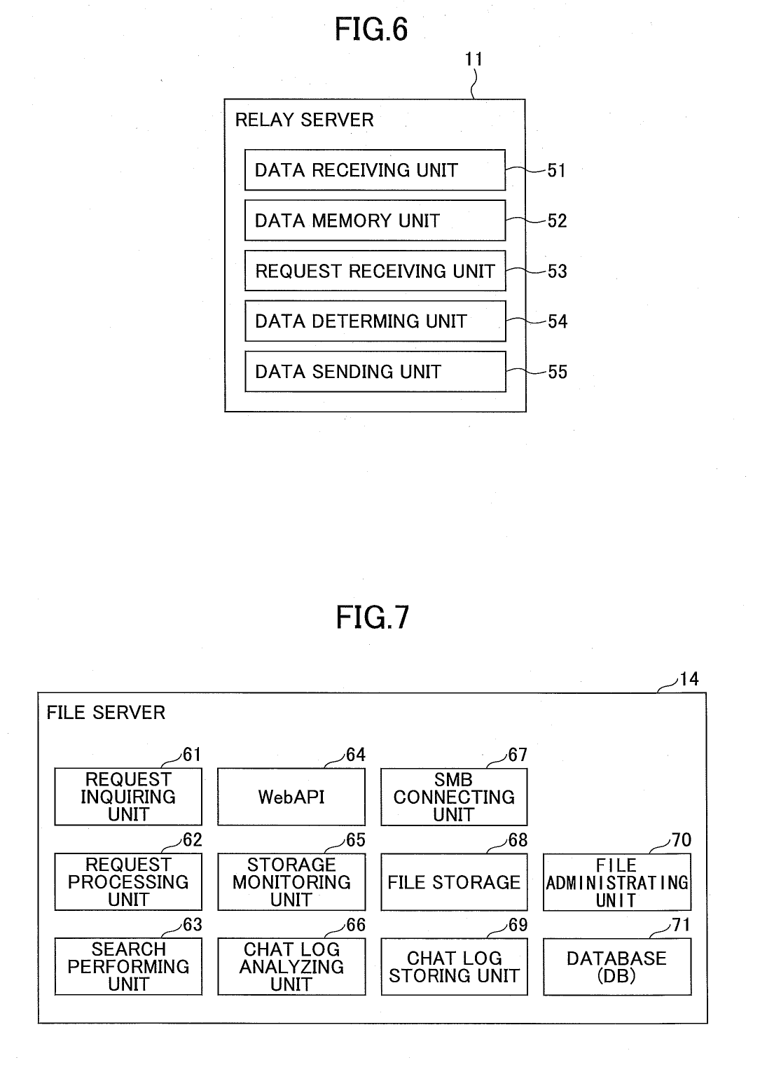

The relay server 11 of the first embodiment is substantialized by the processing block illustrated in, for example, FIG. 6. FIG. 6 is an exemplary processing block chart of the relay server of the first embodiment. For example, the relay server 11 substantializes a data receiving unit 51, a data memory unit 52, a request receiving unit 53, a data determining unit 54, and a data sending unit 55 by running a program.

The data receiving unit 51 receives various requests such as a search request from the smart device 13 connected to, for example, the network N1. For example, a smart device ID indicative of the smart device 13 at a transmission source and a file server ID indicative of the file server 14 at a transmission destination are included in various requests such as a search request. The data memory unit 52 stores various requests such as the search request received by the data receiving unit 51. The request receiving unit 53 receives an inquiry of whether there is a request from the file server 14.

The data determining unit 54 determines whether the various requests such as the search request whose transmission destination is the inquired file server 14 are stored in the data memory unit 52. The data sending unit 55 sends the various requests such as the search request whose transmission destination is the inquired file server 14 to the inquired file server 14.

When the relay server 11 sends the message to the smart device connected to the network N2, the message is temporarily received by the relay server 13 and the received message is delivered to the smart device 13 connected to the network N2.

### <<File Server>>

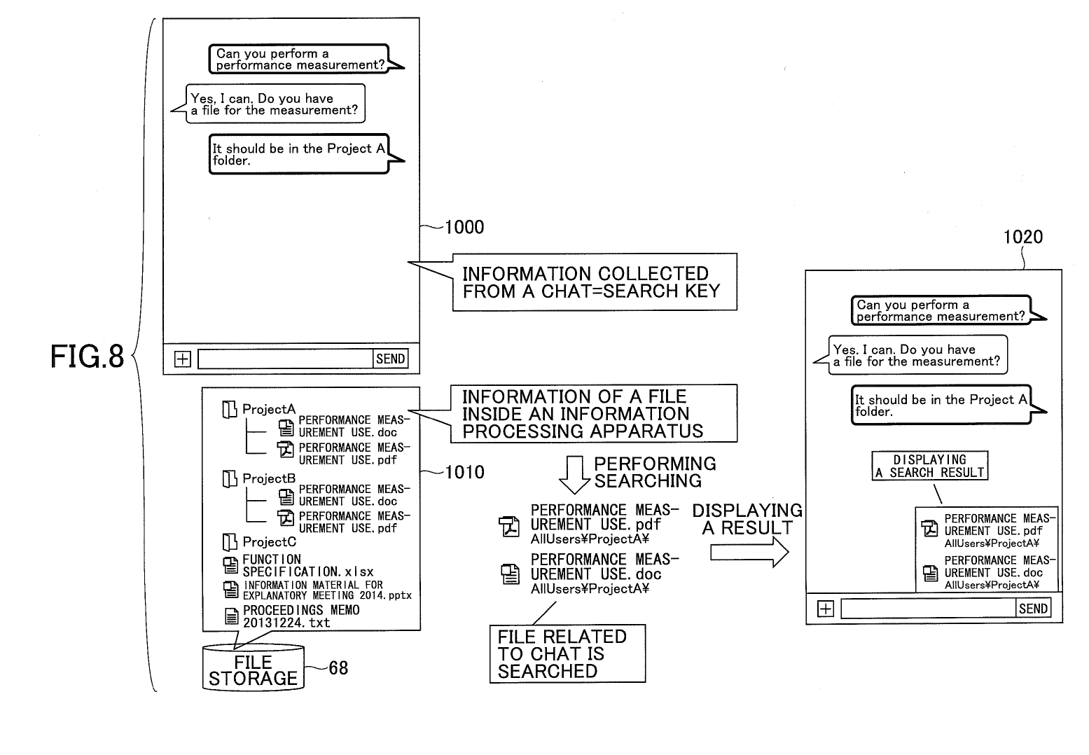

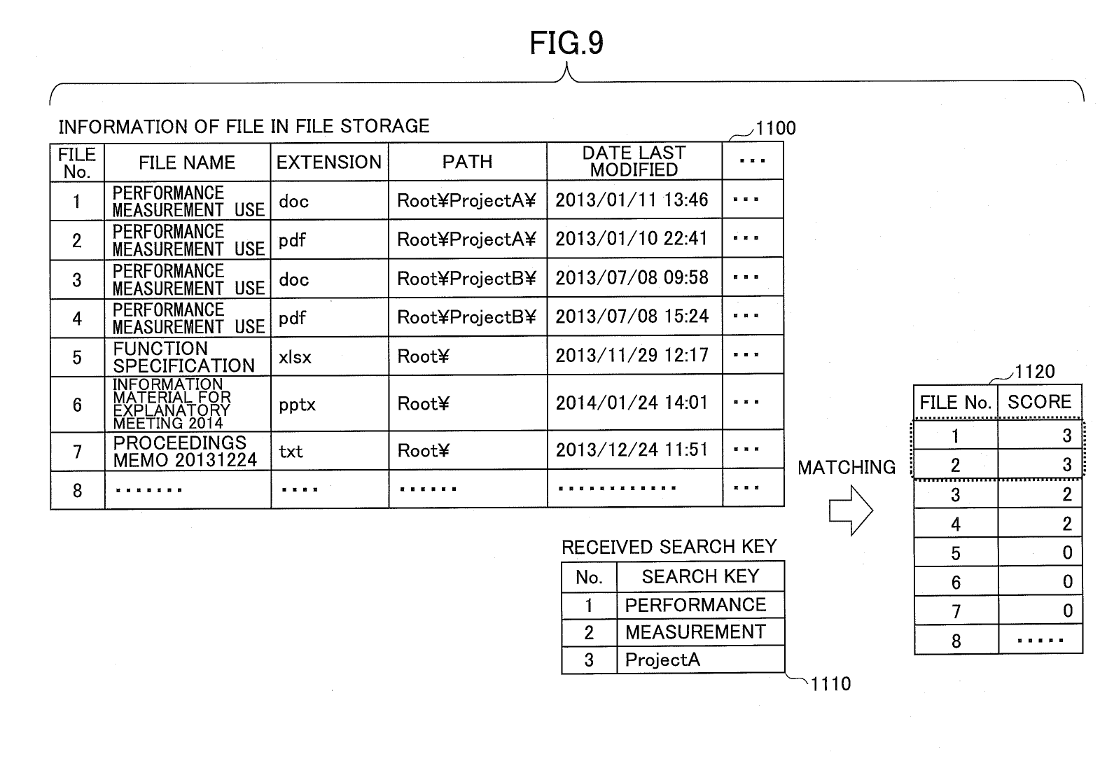

The file server 14 of the first embodiment is substantialized by the processing block illustrated in, for example, FIG. 7. FIG. 7 is an exemplary processing block chart of the file server of the first embodiment. For example, the file server 14 substantializes a request inquiring unit 61, a request processing unit 62, a search performing unit 63, a WebAPI 64, a storage monitoring unit 65, a chat log analyzing unit 66, an SMB connecting unit 67, a file storage 68, a chat log storing unit 69, a file administrating unit 70, and a database (DB) 71 by running a program.

The request inquiring unit 61 inquires the relay server 11 of whether various requests such as the search request exist or not. The request processing unit 62 performs a process based on the various requests such as the search request. The search performing unit 63 performs a file search using a search key.

The WebAPI 64 is an interface for acquiring a file from the smart device 13 and storing the file. The storage monitoring unit 65 monitors the file storage 68 and detects a registration of the file and an edit of the file. The chat log analyzing unit 66 performs an analysis of a chat log. The SMB connecting unit 67 is an interface for acquiring the file from the PC 15 using an SNB protocol and storing the file.

The file storage 68 stores the file. The chat log storing unit 69 stores a message of a chat as a chat log. The file administrating unit 70 collects information of the file stored in the file storage 68 and stores and administers the collected file information. The DB 71 stores the file information stored in the file storage 68.

### <Detailed Process>

Hereinafter, a detailed process of the information processing system 1 of the first embodiment is described.

### <<Summary of Search>>

The information processing system 1 of the first embodiment search the file related to the message of the chat by performing the search in the files stored in the file server 14 as illustrated in, for example, FIG. 8.

FIG. 8 schematically illustrates a file search of the first embodiment. Exchanges of messages are conducted between the smart devices 13 as on a chat screen 1000 illustrated in, for example, FIG. 8. Further, the files are stored in the file storage 68 of the file server 14 to form a file hierarchy as on a file view 1010 illustrated in FIG. 8.

The file server 14 determines a search key according to a method described below based on a content of a message input on the chat screen 1000 or an operation on the chat screen. For example, the file server 14 analyzes the chat log and determines the search key related to the message of the chat. The file server 14 may determine a keyword designated by the search command as the search key. Further, the file server 14 may receive an operation of selecting the message displayed on the chat screen 1000 from the user and may determine the selected message as the search key.

Here, described is an example where the chat log is analyzed and the search key related to the message of the chat is determined. For example, “performance”, “measurement”, and “Project A” are determined as the search key on the chat screen 1000 illustrated in FIG. 8.

Further, the file administrating unit 70 of the file server 14 collects the file information stored so as to have the file hierarchy as in a file view 1010, stores in the DB 71, and administers the file information. The search performing unit 63 of the file server 14 searches the file information stored in the DB 71. The file information is described in detail later.

The search performing unit 63 searches the file information of the file of a search target using the determined search key so as to search a file related to the message on the chat screen 1000. For example, in the chat screen 1000 and the file view 1010 illustrated in FIG. 8, the search performing unit 63 searches “ProjectA¥performance measurement use.pdf” and “ProjectA¥performance measurement use.doc”.

The smart device 13 receives the search result from the file server 14 and displays the chat screen 1020 on which the file related to the message is displayed as the search result. On the chat screen 1020 illustrated in FIG. 8, “ProjectA¥performance measurement use.pdf” and “ProjectA¥performance measurement use.doc” are displayed as the files related to the message.

The file server 14 may directly send the search result to the smart device 13 or may deliver to the smart device 13 in the same group through the chat server 12.

### <<Search Process>>

FIG. 9 illustrates the file search process of the first embodiment. The file administrating unit 70 of the file server 14 collects the file information 1100 from the file stored in the file storage 68 having the file hierarchy like the file view illustrated in FIG. 8. For example, the search key 1110 is determined as illustrated in FIG. 9.

As illustrated in the file information 1100, a file name, an extension, a path, a date last modified, and so on of a file stored in the file storage 68 of the file server 14 are collected, arranged as the file information 1100, and stored in the DB 71.

The storage monitoring unit 65 of the file server 14 detects a registration of a file in the file storage 68 or an edit of the file stored in the file storage 68 and causes the file administrating unit 70 to update the file information 1100.

The search performing unit 63 of the file server 14 checks whether singular or multiple determined search keys 1110 match the file information 1100 stored in the DB 71 to obtain a score 1120.

Specifically, the search performing unit 63 checks whether the file name, the extension, the path, and the data last modified match a character string of the search key 1110 or not by using the file information 1100 and the search key 1110. If the file name for each file, the extension for each file, the path for each file, and the data last modified for each file, match a character string of the search key 1110, the score corresponding to file is increased. The search performing unit 63 reports at least one file finally having the highest score as the search result by referring to the score 1120. The number of files returned as the search result can be changed by setting the file server 14.

Referring to FIG. 9, it is checked whether the character strings of “performance”, “measurement”, and “ProjectA” match character strings of the file name for each file, the extension for each file, the path for each file, and the date last modified for each file in the file information 1100 or not. As a result, the search result having high scores in FIG. 9 is “ProjectA¥performance measurement use.pdf” and “ProjectA¥performance measurement use.doc”. The search process illustrated in FIG. 9 can be performed at various timings when the file information 1100 and the search key 1110 are updated or at each predetermined time period.

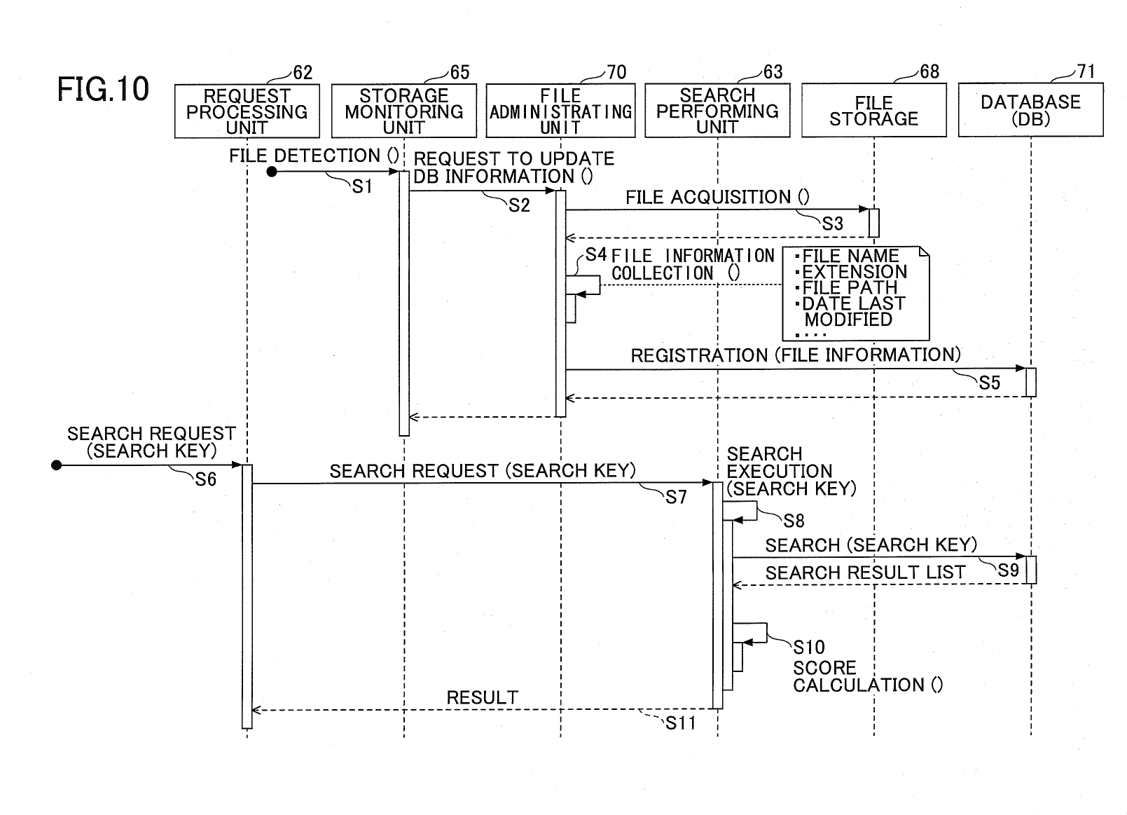

FIG. 10 is an exemplary sequence chart of the file search process of the first embodiment. In step S1, the storage monitoring unit 65 of the file server 14 detects the registration of the file in the monitored file storage 68 and the edit of the file stored in the file storage 68.

In step S2, the storage monitoring unit 65 requests to update the DB information by requesting the file administrating unit 70 to update the file information 1100. In step S3, the file administrating unit 70 acquires the file stored in the file storage 68. In step S4, the file administrating unit 70 collects the file information 1100 from the acquired file. In step S5, the file administrating unit 70 registers (stores) the collected file information 1100 in the DB 71.

In step S6, the request processing unit 62 of the file server 14 receives the search request in which the search key is designated. The request processing unit 62 receives the search request from, for example, the storage monitoring unit 65, the chat log analyzing unit 66, and the request inquiring unit 61.

In step S7, the request processing unit 62 sends a search request to the search performing unit 63 by designating the search key. In step S8, the search performing unit 63 starts searching the file searched using the search key. In step S9, the search performing unit 63 sequentially searches the file information 1100 stored in the DB 71 using the search key and returns a file No. list being an example of the file identification information including the search key to the search performing unit 63.

In step S10, the search performing unit 63 calculates the score 1120 by adding the number of hits in searching the search result list for the search key for each file. In step S11, the search performing unit 63 refers the score 1120 and finally returns several pieces of the file information having the high score.

Referring to the sequence chart of FIG. 10, the file related to the message of the chat can be presented to the user because the file related to the message of the chat can be searched. Therefore, the user can access the file related to the message of the chat.

<<Determination of Search Key from Chat Log>>

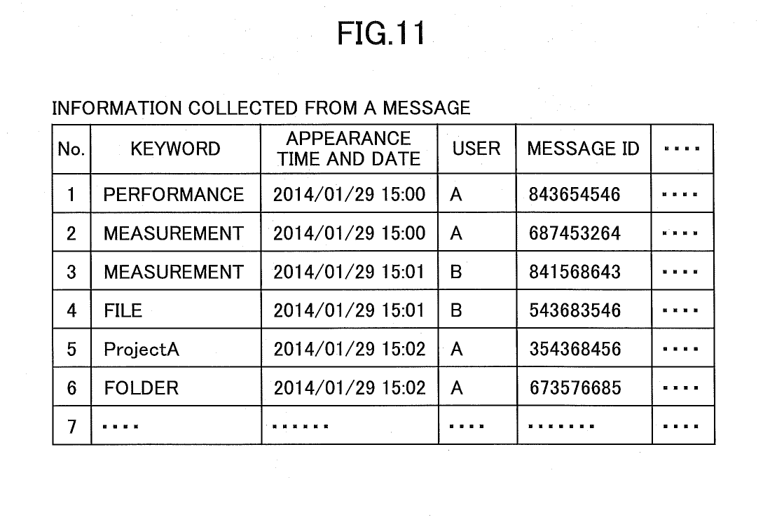

FIG. 11 illustrates an exemplary process of determining the search key from the chat log. The chat log storing unit 69 of the file server 14 receives the message of the chat from the chat server 12 and stores the received message as the chat log. The chat log analyzing unit 66 analyzes the chat log stored in the chat log storing unit 69 and collects the search key information illustrated in FIG. 11.

The search key information illustrated in FIG. 11 is formed so as to include the keyword, the appearance time and date, the user, the message ID, and so on. The keyword is a word extracted from the chat log. The appearance time and date is a date when the keyword appears. The user represents a user who sent the message including the keyword. The message ID is identification information which is allocated to and is peculiar to each message.

A range of the chat log to be analyzed (a range to be collected) can be limited to the message received during 5 minutes immediately before the present time. In this case, the chat log analyzing unit 66 omits the chat log whose appearance time and date is on or before 5 minutes before now.

The chat log analyzing unit 66 can limit a range of a collection target using the number of the messages. For example, the newest 10 messages may be collected. In this case, chat log analyzing unit 66 omits the eleventh newest chat log and succeeding older chat logs from the collection target.

When the keyword indicative of a time and date such as “today” or “yesterday” is included in the chat log, the chat log analyzing unit 66 may convert the keyword to an actual date and time. When the keyword indicative of an application name is included in the chat log, the keyword may be converted to an extension corresponding to the application name. A conversion table used for this conversion may be stored in, for example, the DB 71.

The range of the collection target may be set such that one collection target is set with respect to the file server 14, each group, or each user. The range of the collection target may be set by an administrator of the information processing system 1 or the like or a user participating in the group or the like.

As such, the file server 14 of the first embodiment can determine the search key from the collected search key information.

### <<Determination of Keyword Designated by Search Command as Search Key>>

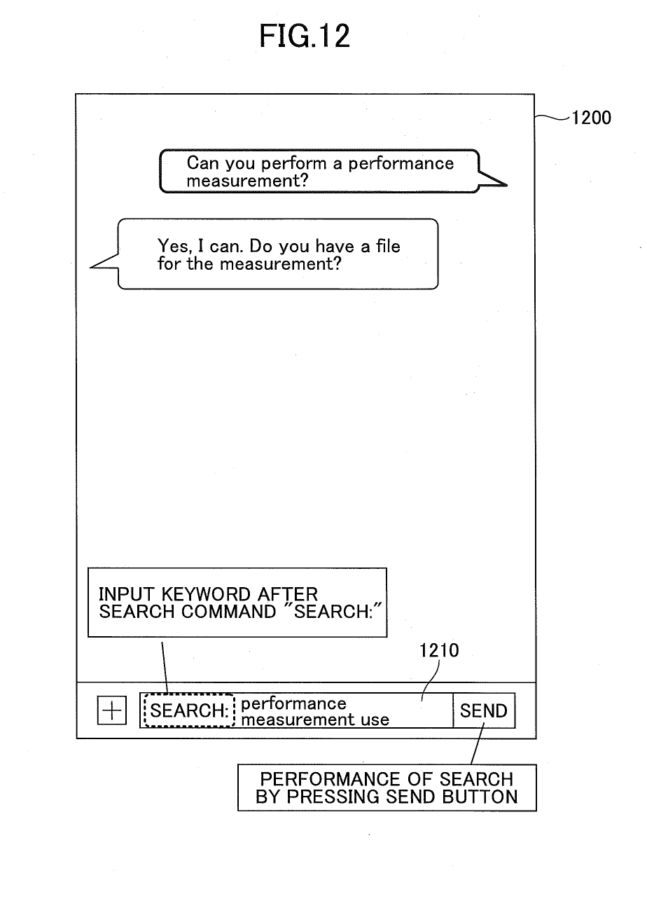

FIG. 12 illustrates an exemplary image of a chat screen on which the keyword is designated for the search command. In a message input box 1210 on the chat screen 1200 of FIG. 12, the keyword of “performance measurement use” is input after “SEARCH:” which is a search command. The user can designate the keyword by inputting a keyword after the search command. Thereafter, the user can start the search of the file by pushing a send button.

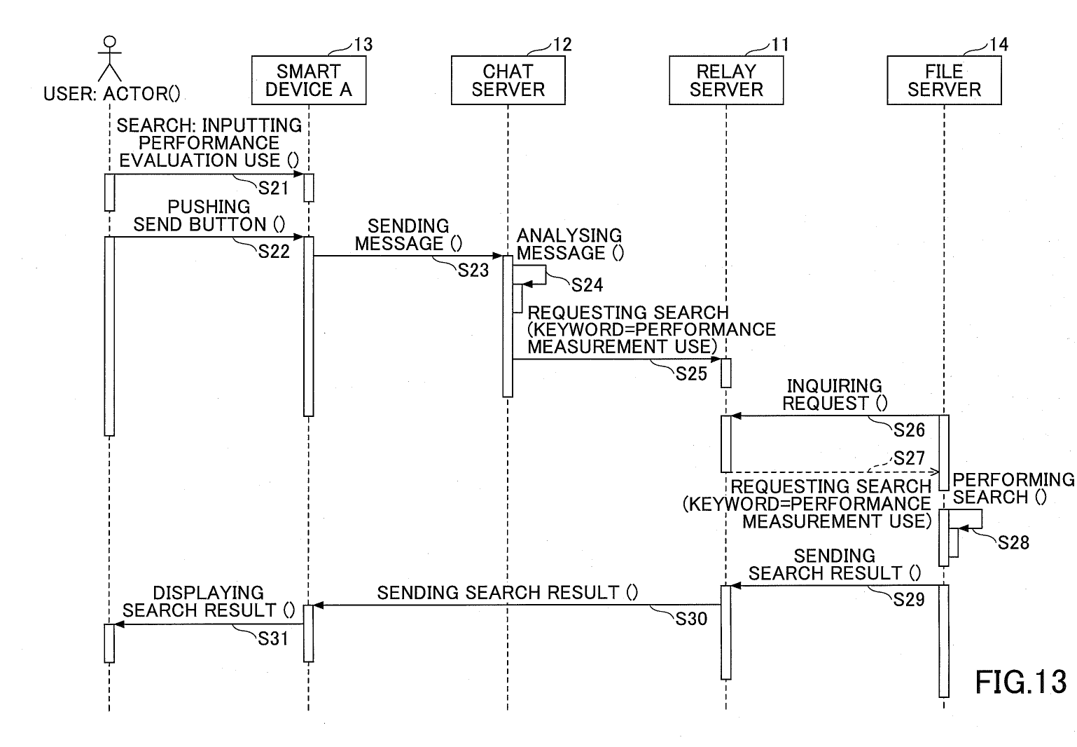

When the send button is pushed, the smart device 13 sends the search command and the keyword to the chat server 12 as a message. When the search command and the keyword are input into the message input box 1210 and the send button is pushed, the process of the information processing system 1 is performed as illustrated in, for example, the sequence chart of FIG. 13.

FIG. 13 is an exemplary sequence chart of the file search process using the search key designated for the search command. In step S21, in a message input box 1210 on the chat screen 1200 of FIG. 21, the keyword of “performance measurement use” is input after “SEARCH:” which is the search command. In step S22, the user pushes the send button provided on the chat screen 1200.

When the send button is pushed, the data sending unit 25 of the smart device 13 sends the search command and the keyword to the chat server 12 as the message in step S23.

In step S24, the message analyzing unit 44 of the chat server 12 analyzes whether the search command is included in the message received from the smart device 13. When the message analyzing unit 44 detects that the search command is included in the message received from the smart device 13, the message analyzing unit 44 instructs the request sending unit 43 to send the search request instead of delivering the message.

In step S25, the request sending unit 43 of the chat server 12 sends the search request, in which the keyword of “performance measurement use” included in the messaged received from the smart device is designated as the search key, to the relay server 11. In step S25, information of smart device 13 at the search request source is included in the search request.

In step S26, the request inquiring unit 61 of the file server 14 inquires the relay server of whether the search request exists or not. In step S27, the request inquiring unit 61 of the file server 14 receives the search request, in which the keyword of “performance measurement use” is designated as the search key, from the relay server 11.

In step S28, the request processing unit 62 of the file server 14 sends the search request to the search performing unit 63 by designating the keyword of “performance measurement use” as the search key. The search performing unit 63 sequentially searches the file information stored in the DB 71 using the designated search key of “performance measurement use”, and returns the search result to the search performing unit 63.

In steps S29-S30, the file server 14 returns the search result to the smart device 13 at the search request source through the relay server 11. In step S31, the display unit 21 of the smart device 13 can display the file related to the message as illustrated in the chat screen 1020 of FIG. 8.

In the sequence chart of FIG. 13, the search request is sent to the file server 14 through the chat server 12. However, the search request may be sent to the file server 14 without going through the chat server 12. In the sequence chart of FIG. 13, the search result is returned to the smart device 13 without going through the chat server 12. However, the search result may be returned to the smart device 13 through the chat server 12.

### <<Determination of Message Selected by User as Search Key>>

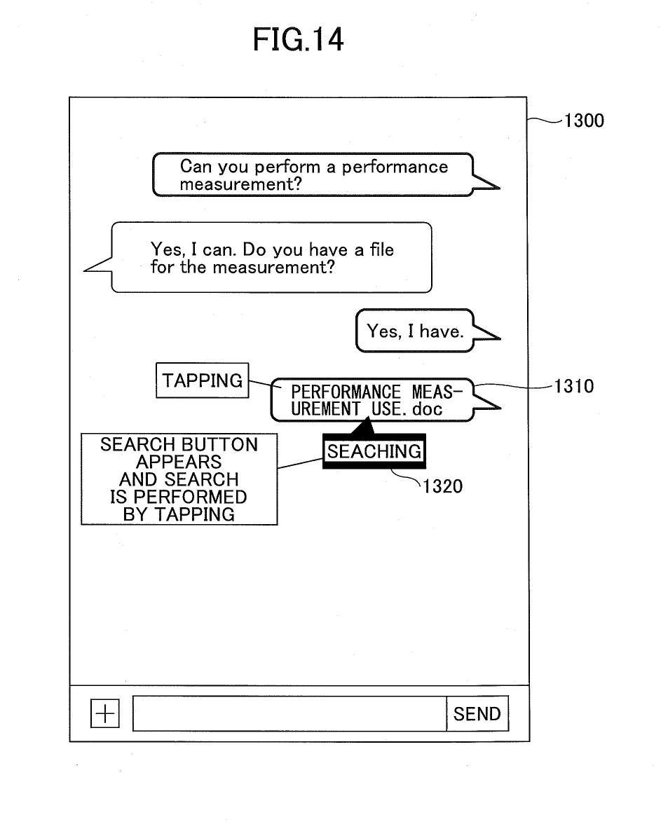

FIG. 14 is an exemplary image chart of the chat screen on which the message is selected as the search key by the user. A search button 1320 is displayed on the chat screen 1300 of FIG. 14 in order to receive an operation such as tapping for selecting the displayed message 1310 from the user. The user can designate the message 1310 as the search key and start the file search by tapping on the search button 1320.

When the search button is tapped, the smart device 13 sends the search request designating “performance measurement use”, which is the content of the message 1310, as the search key to the relay server 11.

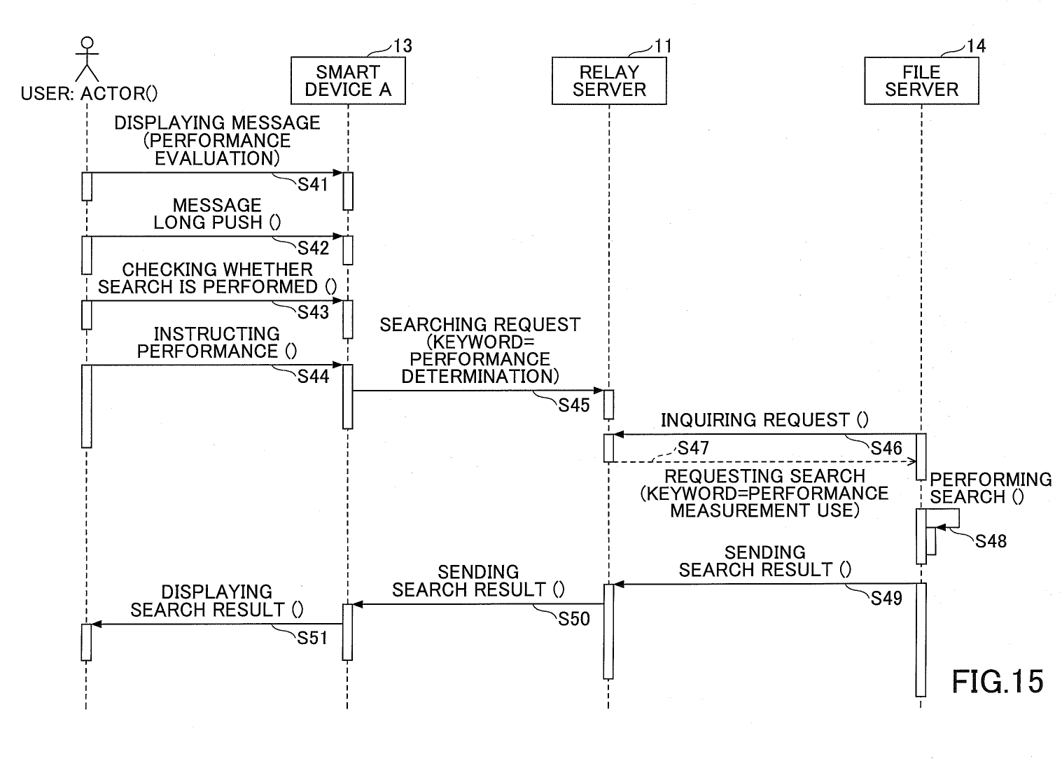

When the message 1310 is selected and the search button 1320 is tapped, the process in the information processing system 1 is as illustrated in, for example, a sequence chart of FIG. 15.

FIG. 15 is an exemplary sequence chart of the file search process using the message selected by the user as the search key. In step S41, the display unit 21 of the smart device 13 displays the chat screen 1300 including the message as illustrated in FIG. 14.

In step S42, for example, the user conducts an operation of a long push on the message 1310 on the chat screen 1300. In step S43, the display unit 21 of the smart device 13 causes the chat screen 1300 to display the search button 1320. The user can designate the message 1310 as the search key and instruct the file search by tapping on the search button 1320 in step S44.

When the search button is tapped, the request sending unit 23 of the smart device 13 sends the search request designating “performance measurement use”, which is the content of the selected message 1310, as the search key to the relay server 11. In step S45, information of smart device 13 at the search request source is included in the search request.

In step S46, the request inquiring unit 61 of the file server 14 inquires the relay server 11 of whether the search request exists or not. In step S47, the request inquiring unit 61 of the file server 14 receives the search request, in which the keyword of “performance measurement use” is designated as the search key, from the relay server 11.

In step S48, the request processing unit 62 of the file server 14 sends the search request to the search performing unit 63 by designating the keyword of “performance measurement use” as the search key. The search performing unit 63 sequentially searches the file information 1100 stored in the DB 71 using the designated search key of “performance measurement use”, and returns the search result to the search performing unit 63.

In steps S49-S50, the file server 14 returns the search result to the smart device 13 at the search request source through the relay server 11. In step S51, the display unit 21 of the smart device 13 can display the file related to the message as illustrated in, for example, the chat screen 1020 of FIG. 8.

In the sequence chart of FIG. 15, the search request is sent to the file server 14 without going through the chat server 12. However, the search request may be sent to the file server 14 through the chat server 12. In the sequence chart of FIG. 15, the search result is returned to the smart device 13 without going through the chat server 12. However, the search result may be returned to the smart device 13 through the chat server 12.

### <<Use of Search Result>>

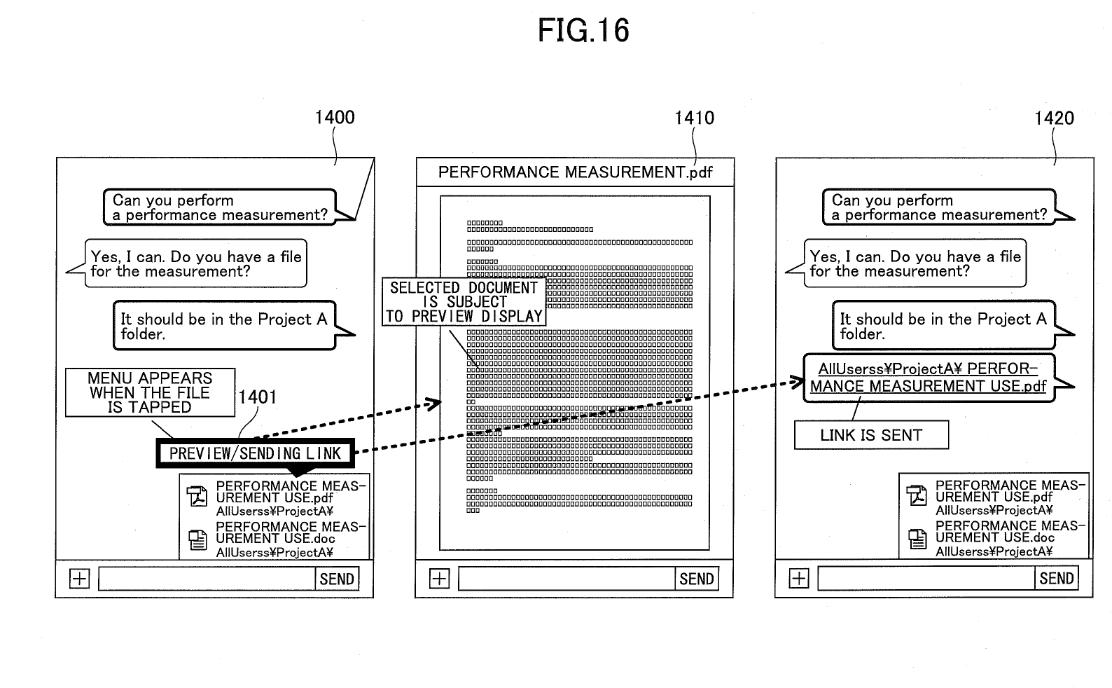

For example, the file related to the message displayed as the search result on the chat screen of FIG. 8 is used as illustrated in FIG. 16. FIG. 16 illustrates an exemplary use of the search result.

On the chat screen 1400 illustrated in FIG. 16, “ProjectA¥performance measurement use.pdf” and “ProjectA¥performance measurement use.doc” are displayed as the search result.

When the operation such as tapping by the user is received on the chat screen 1400, the display unit 21 of the smart device 13 displays a menu 1401 for various operations such as “preview” or “sending link”. When the operation of selecting “preview” is received in the menu 1401 from the user, the smart device 13 acquires the selected file from the file server 14 and displays a preview screen 1410. When the operation of selecting “sending link” is received in the menu 1401 from the user, the smart device 13 delivers a link of the selected file to the smart devices 13 in the same group through the chat server 12 to cause a chat screen 1420 to be displayed on the smart devices 13.

As illustrated in FIG. 16, according to the information processing system 1 of the first embodiment, file sharing between users in the same group and an access to a sharing file can be facilitated.

### [General Overview]

In the information processing system 1 of the embodiment, a sharing file stored in the file server 14 may be browsed while a message is exchanged by a chat function between users belonging to the same group. In the information processing system 1 of the embodiment, the file related to the message exchanged by the chat function between the users can be presented like the chat screen 1400. Therefore, even if the file is stored in a complicated file hierarchy, the user can easily access the sharing file.

The file related to the message exchanged by the chat function between the user can be determined as a file highly probably accessed by the user in the information processing system 1 of the embodiment. Further, it is prospected that the user can find a file whose existence is not noticed or a forgotten file by using the information processing system 1 of the embodiment.

The smart device 13 is an example of a terminal device. The chat server 12 is an example of a second information processing apparatus and a delivery apparatus. The file server 14 is an example of an information processing apparatus and a first information processing apparatus. The file administrating unit 70 is an example of an administration unit. The search performing unit 63 is an example of a search performing unit. The request processing unit 62 is an example of a search result sending unit.

The data receiving unit 26 is an example of a search result receiving unit. The display unit 21 is an example of a display unit. The request sending unit 23 is an example of a request sending unit. The chat log analyzing unit 66 is an example of a search information analyzing unit.

The file is an example of sharing information. The file information 1100 is an example of sharing information. The search key is an example of search information. The link is an example of information for accessing the sharing information.

The embodiment does not limit the scope of the present invention. The present invention is not limited to the structure illustrated in FIG. 1. For example, the relay server 11, the chat server 12, and the file server 14 of the information processing system 1 may be structured by at least one computer. As long as the above function can be performed, any computer has the function. For example, the relay server 11 and the chat server 12 of the information processing system 1 can be structured by one computer.

Further, the information processing system 1 may be structured to connect the chat server 12, the multiple smart devices 13, the file server 14, and the PC 15 through the network N2 such as a LAN. Because the communication beyond the firewall 16 is not performed in the information processing system 1, the relay server 11 can be omitted. Further, the chat server 12 and the file server 14 may be integrated.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority or inferiority of the invention. Although an information processing system has been described in detail, it should be understood that various changes, substitutions, and alterations could be made thereto without departing from the spirit and scope of the invention.

This application is based upon and claims the benefit of priority of the prior Japanese Patent Application No. 2014-086283, filed on Apr. 18, 2014, the entire contents of which are incorporated herein by reference.

What is claimed is:

1. An information processing system comprising a plurality of terminal devices and at least one information processing apparatus,
wherein each of the at least one information processing apparatus includes
an administrating unit that administrates information related to sharing information shared between the plurality of terminal devices,
a search performing unit that searches the information related to the sharing information to find the information related to the sharing information as a search target based on a search request in which search information is designated,
a search result sending unit that sends a search result to the plurality of terminal devices,
wherein each of the plurality of terminal devices includes
a search result receiving unit that receives the search result, and
a display unit that displays information exchanged between the plurality of terminal devices and the received search result.

2. The information processing system according to claim 1,
wherein each of the plurality of terminal devices further includes
a request sending unit that requests the at least one information processing apparatus to send the sharing information based on the search result displayed on the display unit when a display request to display the sharing information is received from a user, and causes the display unit to display the sharing information received from the at least one information processing apparatus.

3. The information processing system according to claim 1,
wherein each of the plurality of terminal devices further includes
a request sending unit that requests a delivery apparatus that delivers the information exchanged between the plurality of terminal devices to report information for accessing the sharing information based on the search result displayed on the display unit when a report request to report the information for accessing the sharing information is received from a user, and causes the terminal device to deliver the information for accessing the sharing information.

4. The information processing system according to claim 1,
wherein the at least one information processing apparatus includes
a search information analyzing unit that analyzes the information exchanged between the plurality of terminal devices and determines the search information.

5. The information processing system according to claim 1,
wherein the at least one information processing apparatus receives the search request in which the search information is designated.

6. The information processing system according to claim 1,
wherein the at least one information processing apparatus receives information selected by a user among information which is exchanged between the plurality of terminal devices and displayed on the display unit as the search request in which the search information is designated.

7. An information processing apparatus connected to a plurality of terminal devices so as to be communicable with the plurality of terminal devices, the information processing apparatus comprising
an administrating unit that administrates information related to sharing information shared between the plurality of terminal devices;
a search performing unit that searches the information related to the sharing information to find the information related to the sharing information as a search target based on a search request in which search information is designated; and
a search result sending unit that sends a search result to the plurality of terminal devices and causes the plurality of terminal devices to display information exchanged between the plurality of terminal devices.

8. A non-transitory computer-readable storage medium storing programs representing a sequence of instructions, the programs which when executed by a computer installed in an information processing apparatus connected to a plurality of terminal devices so as to be communicable with the plurality of terminal devices through a network, the instructions cause the processing unit to functions as:
an administrating unit that administrates information related to sharing information shared between the plurality of terminal devices;
a search performing unit that searches the information related to the sharing information to find the information related to the sharing information as a search target based on a search request in which search information is designated; and
a search result sending unit that sends a search result to the plurality of terminal devices and causes the plurality of terminal devices to display information exchanged between the plurality of terminal devices.
